(19) United States
(12) Patent Application Publication
(10) Pub. No.: US 2022/0411296 A1
(43) Pub. Date: Dec. 29, 2022

(54) Liquid Medium Purification and Stirring Device

(71) Applicant: Jennifer Armitage, Mission (CA)

(72) Inventor: Jennifer Armitage, Mission (CA)

(21) Appl. No.: 17/847,374

(22) Filed: Jun. 23, 2022

Related U.S. Application Data
(60) Provisional application No. 63/216,222, filed on Jun. 29, 2021.

(51) Int. Cl. C02F 1/72; C02F 1/50

(52) U.S. Cl. CPC C02F 1/722; C02F 1/50; C02F 2303/04; C02F 2103/42

(57) ABSTRACT

The present invention relates to a liquid and drink purification and stirring device. The device is handheld and can be used for a variety of liquid drinks, such as water, juices and wines. The device is designed like a stirring rod or straw and has the material composition that enables the device to attract and adhere various solutes thereto when suspended in liquid mediums. The device features an elongated wand and a handle. The wand is made from food-grade copper and when submerged in a liquid, attracts unnatural solutes, and kills pathogens such as bacteria, algae, viruses and many more. The handle can be made from any food grade and FDA approved material and can be integrated or removably-attached to the wand. The device is also used for stirring the liquid and enables consumers to play a greater role in managing their own health and to prohibit consumption of pathogens

### CROSS-REFERENCE TO RELATED APPLICATION

The present application claims priority to, and the benefit of, U.S. Provisional Application No. 63/216,222, which was filed on Jun. 29, 2021 and is incorporated herein by reference in its entirety.

### FIELD OF THE INVENTION

The present invention relates generally to liquid purification devices. More specifically, the present invention relates to a handheld purification and stirring device for a variety of liquids you instead to ingest or be submerged in. The device is designed tool and has the material composition that enables the device to attract and adhere to various solutes (natural and artificial sulphites) when suspended in liquid mediums. The device features a wand (along with many other shapes and designs) which when submerged in a liquid attracts unnatural solute thereto and kills pathogens such as bacteria, algae, viruses and many more. The device is also used for stirring the liquid and offers consumers a way to go beyond organic, ensuring the highest quality of product. Accordingly, the present disclosure makes specific reference thereto. Nonetheless, it is to be appreciated that aspects of the present invention are also equally applicable to other like applications, devices, and methods of manufacture.

### BACKGROUND

By way of background, every individual requires at least 20 to 40 liters of clean, safe water each day for drinking, cooking, and hygiene. In particular, drinking clean and safe water is a basic necessity. Access to clean and safe drinking water is a major issue that affects individuals from all walks of life around the world. Many water supplies are contaminated with harmful bacteria and algae, as well as allergens. Polluted and contaminated water is not just dirty but can be fatal. Contaminated water can cause water borne diseases like cholera.

Therefore, widespread availability of clean drinking water is a major initiative for governments across the world. However, certain groups of individuals across the world continue to bear the burden of disease-related water pathogens since they cannot afford clean water required for daily consumption. This is despite the fact that a number of water purification techniques are available to address the many health challenges associated with untreated water. Many individuals do not have an easy and portable solution that they can implement themselves before drinking water or any other liquid for purification.

One notable solute in water supplies is sulfite which is also a common food additive. All grape wines contain sulfites as a natural byproduct of fermentation, but the majority of sulfites are added prior to bottling. Excess sulfites, however, impart an undesirable taste and may pose severe health risks (including worsening and developing autoimmune diseases). Many consumers report adverse reactions to sulfite exposure, and sulfite allergies are common, especially among asthmatics. Individuals may experience side effects, such as headaches, hives, swelling, stomach pain and diarrhea. In those individuals afflicted with asthma, sulfite compounds can also irritate the respiratory tract. Further, in wine, sulfites may leave a bitter taste.

Generally, individuals depend on processing of water and other drinks by machines or processing facilities for safe water. However, individuals do not have a handy and portable solution where they can take part in achieving the health benefits of always drinking safe water and drinks. Individuals desire a method to extend water purification beyond organic methods and also to play a greater role in consuming clean and safe water and other drinks, in order to manage their own health and what goes into their bodies.

Therefore, there exists a long felt need in the art for an improved water purifying solution that can be used by individuals themselves for purification of a liquid before drinking the liquid such as water. There is also a long felt need in the art for a water purification device that enables consumers to play a greater role in managing their own health and what goes into their bodies. Additionally, there is a long felt need in the art for a water purification system that provides a solution to ingesting contaminated drinking products. Moreover, there is a long felt need in the art for a handheld water purification device that can be used for purification of different types of drinking products. Furthermore, there is a long felt need in the art for a drink-purification device that kills pathogens in drinking products, and attracts/adheres various solutes, such as sulfites thereto. Finally, there is a long felt need in the art for a purifying device that is made of a material composition that does not modify the properties and taste of a drinking product while killing all, or most of, the pathogens therein for providing the highest quality of a drinking product.

The subject matter disclosed and claimed herein, in one embodiment thereof, comprises a portable liquid drink stirring and purification handheld device. The device is designed to be long and thin like a stirring rod or straw and provides consumers a method for purifying their drinks before consuming. The device features an elongated wand having a top end and a bottom end, the top end includes a handle for gripping the device by a consumer during use, the wand is submerged in a liquid for purifying and stirring the liquid wherein the wand has a material composition of food-grade copper and the handle has a material composition of food grade material. The wand when submerged and stirred, attracts the unnatural solutes, and kills the pathogens contained in the liquid drink.

In this manner, the drinking product purifying device of the present invention accomplishes all of the foregoing objectives and provides users with an improved solution to ingesting contaminated drinking products. The device allows a consumer to purify the drink themselves by an easy step of stirring the drink with the device and thereby killing bacteria, algae, viruses, and many more pathogens contained in the drinking beverage. The device can be used for purifying various types of drinks including, but not limited to, water, juices, wine, and many more. The device can be configured in various sizes allowing the consumers to use with containers of various sizes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a liquid drink stirring and purification device. The device is designed to be long and thin like a stirring rod, wand, or straw-type element. The device further comprising an elongated wand having a top end and a bottom end, the top end includes an integrated handle for gripping the device by a consumer, the wand is used for submerging in a liquid for purifying and stirring the liquid wherein the wand has a material composition of food-grade copper and the handle has a material composition of food-grade material. The wand when submerged and stirred, attracts the unnatural solutes, and kills the pathogens contained in the liquid drink.

In yet another embodiment, the unnatural solutes include sulfites that are attracted and adhere to the wand immersed in a liquid.

In yet another embodiment, the wand kills bacteria, algae, viruses, and many more pathogens, and can be used for a variety of liquids such as water, juices, wine, and other liquids.

In yet another embodiment, the handle and the wand are molded and integrated, or alternatively, the handle is removably-attached to the wand.

In yet another embodiment, the handle can have any shape and size and can be attached to the wand through a screwing, threading, mating, or attachment mechanism and a solid one piece.

In yet another embodiment of the present invention, a method for purifying a liquid drink by a consumer before drinking is described. The method includes the steps of: initially providing a stirring and purification device to the consumer, the device comprising a rod-shaped wand made out of food-grade copper and a handle made out of material; submerging the wand into a container containing the liquid for attracting and adhering the sulfites and other unnatural solutes in the liquid, and for killing the pathogens; stirring the wand to create a motion in the liquid and to attract and adhere all the sulfites and pathogens thereto, and removing the wand for providing a purified and uncontaminated liquid drink for the consumer.

In yet another embodiment, a material composition for purifying a liquid for consumption is disclosed. The material composition is used for manufacturing a stirring rod device that is used for stirring liquids for purification. The material composition comprises: food-grade and FDA approved copper that has natural properties of purifying a liquid, such as water by killing pathogens such as bacteria, viruses, and others, and hydrogen peroxide for oxidizing unnatural solutes, such as sulfite for reducing harmful effects on a consumer. The stirring rod type device includes a handle that is made out of FDA approved and food-grade material.

To the accomplishment of the foregoing and related ends, certain illustrative aspects of the disclosed innovation are described herein in connection with the following description and the annexed drawings. These aspects are indicative, however of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a liquid medium purifying device of the present invention in accordance with the disclosed architecture;

FIG. 2 illustrates a diagrammatic representation of an exemplary composition of one potential embodiment of the liquid medium purifying device in accordance with the disclosed architecture;

FIG. 3 illustrates exemplary handles that can be used in one potential embodiment of the drink-purifying device of the present invention in accordance with the disclosed architecture; and

FIG. 4 illustrates a flow diagram showing exemplary steps performed for decontaminating a liquid drink using one potential embodiment of the stirrer and purifying device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved water-purifying solution that can be used by individuals themselves for purification of a liquid before drinking the liquid, such as water. There is also a long felt need in the art for a water purification device that enables consumers to play a greater role in managing their own health and what goes into their bodies. Additionally, there is a long felt need in the art for a water purification system that provides a solution to ingesting contaminated drinking products. Moreover, there is a long felt need in the art for a handheld water purification device that can be used for purification of different types of drinking products. Furthermore, there is a long felt need in the art for a drink-purification device that kills pathogens in drinking products and attracts/adheres various solutes, such as sulfites, thereto. Finally, there is a long felt need in the art for a purifying device that is made of a material composition that does not modify the properties and taste of a drinking product while killing all the pathogens for providing the highest quality of a drinking product.

The present invention, in one exemplary embodiment, is a novel method for purifying a liquid drink by a consumer before drinking. The method includes the steps of: initially providing a liquid stirring and purification device to the consumer, wherein the device comprises a rod-shaped wand made out of food-grade copper and a handle made out of any material; submerging the wand into a container containing the liquid for attracting and adhering the sulfites and other unnatural solutes in the liquid and for killing pathogens; stirring the wand to create a motion in the liquid and to attract/adhere all the sulfites and pathogens thereto; and removing the wand for providing a purified and uncontaminated liquid drink for the consumer.

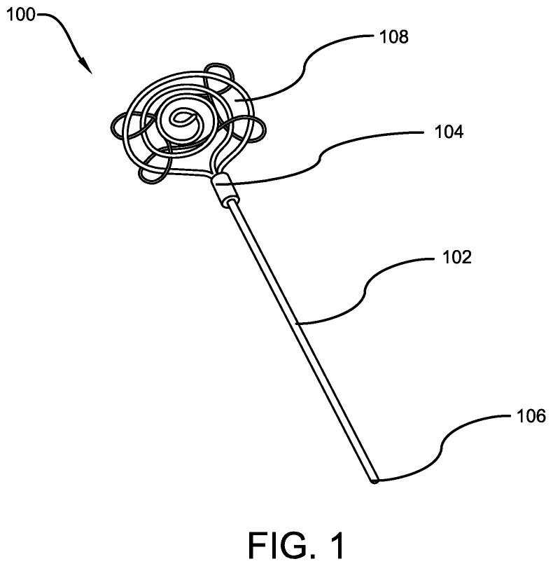

Referring initially to the drawings, FIG. 1 illustrates a perspective view of one potential embodiment of a liquid medium purifying device 100 of the present invention in accordance with the disclosed architecture. FIG. 1 shows several advantageous features of the present invention, however, as will be described below, the invention can be provided in various shapes, sizes, combinations of features and components, and varying numbers and functions of the components.

The drink-purifying device 100 is designed to be a long and thin rod, configured similar to a stirring rod or straw. The design allows for easy mixing of the liquid medium while purifying the liquids. More specifically, the purifying device 100 includes an elongated and solid rod or wand 102 having a first (top) end 104 and a second (bottom) end 106, the first end 104 includes a handle structure 108 that is used by a user for holding the device 100 for stirring the liquid medium. The handle structure 108 is preferably in the form of a spiral, that provides good surface area for the user to hold the device 100. The elongated rod 102 is submerged in the liquid medium for stirring the liquid and the material composition of the device 100 enables the device 100 to attract and adhere various solutes thereto when suspended in the liquid medium. The handle 108 comprises buoyant material to prevent the wand 102 from sinking to the bottom of the liquid or fluid container. The device 100 attracts and adheres all sulphites present in the liquid medium while also killing bacteria, algae, viruses, and other pathogens contaminating the liquid medium. Sulfites or sulphites are compounds that contain the sulfite ion, SO²⁻₃. The sulfite ion is the conjugate base of bisulfite. Although its acid is elusive, its salts are widely used. Sulfites are substances that naturally occur in some foods and the human body. They are also used as regulated food additives. Sulphites can trigger asthma and symptoms of an anaphylactic reaction. Many people who have asthma may also have a sulphite sensitivity. Also, sulfites create and worsen auto-immune disorders and other diseases. The device 100 can be used for purifying/cleaning drinking and bathing water, as well as for purifying any store-bought products such as juices or wines, sauces, canned goods, etc.

The device 100 comes in a variety of sizes allowing a user to easily stir and decontaminate any number of liquid medium volumes. The device 100 can have a size or length in the range of from about 4 inches to about 8 inches for decontaminating drinking liquid mediums such as drinking water, juices, wines, and anything liquid. The device 100 can have a larger size in any range for decontaminating bathing water and pools.

In use, a user simply submerges the wand 102 into a container of liquid and stirs the wand 102 around, thereby allowing unnatural solutes that the rod 102 comes into contact with to be diffused in the liquid solution.

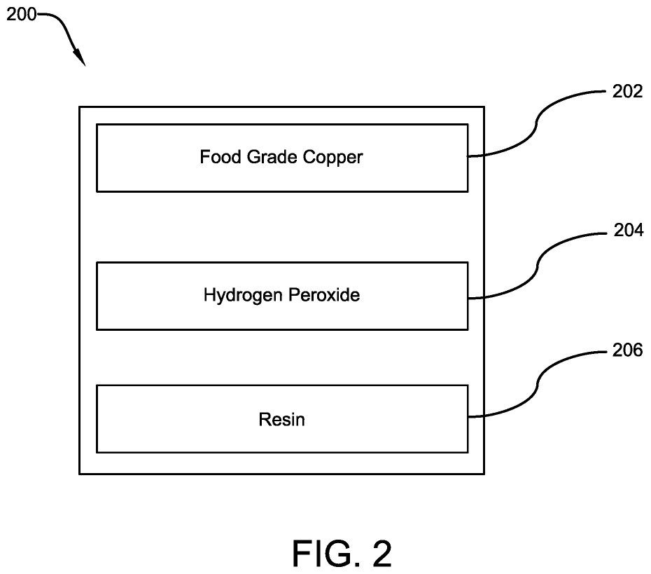

FIG. 2 illustrates a diagrammatic representation of an exemplary composition of the liquid medium purifying device 100 in accordance with the disclosed architecture. The material composition 200 of the device 100 enables the device 100 to attract and adhere to various solutes when suspended in various liquid mediums. The exemplary material composition 200 includes food-grade and FDA-approved copper 202. The copper 202 comprises the main component of the material composition 200 and creates a natural purification process of a liquid medium and helps in killing all, or a majority of, the microorganisms, molds, fungi, algae, and bacteria, present in a liquid, and especially water, that could be harmful to a consumer and helps in making the water fit for consumption. In addition to copper 202, the composition may have traces of hydrogen peroxide 204 that includes the properties of oxidizing sulfites into hydrogen sulfate that do not cause the health problems associated with the sulfites. Copper 202 also includes the properties of removing sulfites from a drink. The rod/wand is made from material composition 200 and acts as a magnet/filter where the composition also allows sulfites to create covalent bonds with the magnet/filter to attract and adhere sulfites thereto. The material composition 200 allows sequestering sulfites and thus provides a solution to ingesting contaminated drinking products. The composition 200 purifies the drink or liquid medium in a manner similar to a tea bag. After a liquid is stirred with the device 100 of the present invention having the material composition 200, the liquid medium has a reduced amount of free sulfite and pathogens but retains the general non-sulfite compounds while maintaining the original taste of the drink. The material composition 200 is present on the surface of the rod 102 in solid phase and is capable of sequestering free sulfite from the liquid medium comprising free sulfite. The handle 108 of the device 100 can be made out of any material 206 wherein the used material is also FDA approved. Alternatively, the handle 108 can be made from anything FDA approved and food grade.

It should be noted that in some potential embodiments of the present invention, the material composition 200 can include food grade and FDA-approved copper.

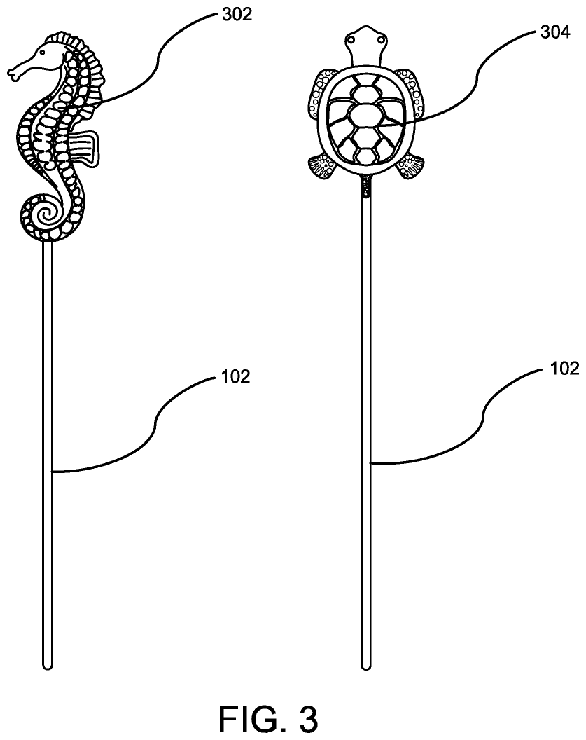

FIG. 3 illustrates exemplary handles that can be used in the drink purifying device 100 of the present invention in accordance with the disclosed architecture. The drink-purifying device 100 can come in various designs as per preferences of the consumers. For providing an aesthetic appeal to the device, the handle 108 can be of unlimited designs. FIG. 3 illustrates a pair of potential embodiments, wherein the handle 302 is of a dragon shape and can be made from resin or wood or any FDA and food grade approved material. The handle 304 is of a turtle shape and can also be made from resin or Wood or any food grade and FDA approved material. It should be understood that there is no limit on the possible designs and size of the handles that are used with the device 100. The handles can be integrated and molded to the wand 102, or alternatively can be detachably attached to the wand 102 using a screwing and threading mechanism and can be completely whole.

The wand 102 can be food-grade and can have a diameter in the range of from about Diameter Nominal (DN) 2 mm to about Diameter Nominal (DN) 20 mm. Further, the wand 102 is void of tin, nickel, or steel fillings or linings. Commercially, the device 100 of the present invention can come in packages of one device, five devices, ten devices, twenty devices or a hundred devices. Packages of any other number can also be developed as per the preference of the users.

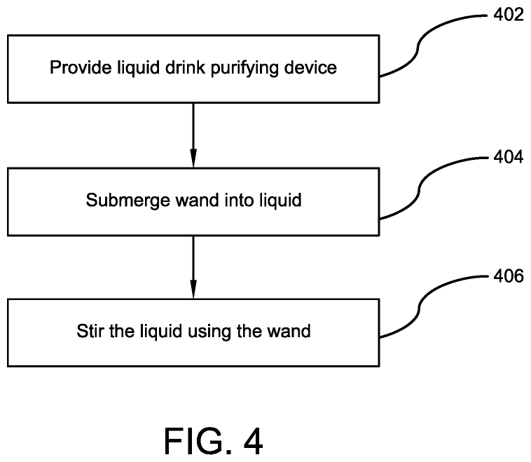

FIG. 4 illustrates a flow diagram showing exemplary steps performed for decontaminating a liquid drink using the stirrer and purifying device 100 of the present invention in accordance with the disclosed architecture. Initially, a consumer is provided with the purifying device 100 of the present invention (Block 402). The consumer then submerges the wand into a container of liquid allowing the wand to attract the pathogens and other solutes present in the liquid. The unnatural solutes move to the wand 102 and adhere to the wand 102 (Block 404). Attracting the solutes like a magnet/filter and killing germs, viruses, algae etc. Then, the consumer stirs the liquid using the wand 102 by holding the device 100 with the handle 108, and thereby creates a movement in the liquid that enhances the process of attracting the pathogens to the wand (Block 406).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drink-purifying device”, “liquid-purifying device”, “stirrer and purifying device”, “liquid medium purifying device”, “purification device”, “purifying device”, and “device” are interchangeable and refer to the liquid medium purifying device 100 of the present invention.

Notwithstanding the foregoing, the liquid medium purifying device 100 of the present invention can be of any suitable size and configuration as is known in the art, without affecting the overall concept of the invention, provided that it accomplishes the above-stated objectives. One of ordinary skill in the art will appreciate that the size, configuration and material of the liquid medium purifying device 100 as shown in the FIGS. are for illustrative purposes only, and that many other sizes and shapes of the liquid medium purifying device 100 are well within the scope of the present disclosure. Although the dimensions of the liquid medium purifying device 100 are important design parameters for user convenience, the liquid medium purifying device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A liquid purifying device comprising:
a rod for stirring a liquid medium for consumption;
wherein said rod comprises a solid rod having a first end and a second end, wherein said first end includes a handle used by a user for holding said liquid purifying device; and
wherein said rod comprises a material composition selected from a group consisting of a copper and a hydrogen peroxide to attract and adhere sulphites in the liquid medium thereto, and to kill pathogens therein.

2. The liquid purifying device of claim 1, wherein said handle comprises a material selected from a group consisting of any food grade and FDA approved material.

3. The liquid purifying device of claim 2, wherein said handle is buoyant.

4. The liquid purifying device of claim 3, wherein said pathogens is selected from a group consisting of a bacteria, an algae and a virus.

5. The liquid purifying device of claim 4, wherein the liquid medium is a drinking liquid medium selected from a group consisting of a water, a juice, and a wine.

6. The liquid purifying device of claim 5, wherein said rod includes a length generally from about 4 inches to about 8 inches.

7. The liquid purifying device of claim 5, wherein said rod includes a length generally from about 1 foot to about 2 feet for decontaminating bathing water and pools.

8. The liquid purifying device of claim 6, wherein said rod includes a diameter generally from about Diameter Nominal (DN) 2 mm to about Diameter Nominal (DN) 20 mm.

9. The liquid purifying device of claim 7, wherein said rod includes a diameter generally from about Diameter Nominal (DN) 2 mm to about Diameter Nominal (DN) 20 mm.

10. The liquid purifying device of claim 8, wherein said copper includes a food-grade copper.

11. The liquid purifying device of claim 10, wherein said pathogens are selected from a group consisting of a microorganism, a mold and a fungi.

12. A liquid purifying device comprising:
an elongated rod for stirring a liquid medium for consumption;
wherein said elongated rod comprises a solid rod having a first end and a second end, wherein said first end includes a handle used by a user for holding said liquid purifying device;
wherein said elongated rod comprises a material composition selected from a group consisting of a copper and a hydrogen peroxide to attract and adhere sulphites in the liquid medium thereto, and to kill pathogens therein;
wherein the liquid medium is a drinking liquid medium selected from a group consisting of a water, a juice, and a wine;
wherein said handle is buoyant; and
further wherein said elongated rod includes a diameter generally from about Diameter Nominal (DN) 2 mm to about Diameter Nominal (DN) 20 mm.

13. The liquid purifying device of claim 12, wherein said handle comprises a material selected from a group consisting of any food grade and FDA approved material.

14. The liquid purifying device of claim 13, wherein said pathogens is selected from a group consisting of a bacteria, an algae and a virus and any foreign bodies.

15. The liquid purifying device of claim 14, wherein said elongated rod includes a length generally from about 4 inches to about 8 inches.

16. The liquid purifying device of claim 15, wherein said copper includes a food-grade copper.

17. The liquid purifying device of claim 16, wherein said pathogens is selected from a group consisting of a microorganism, a mold and a fungi and a algae.

18. A drink purifying device comprising:
an elongated rod for stirring a liquid medium for consumption;
wherein said rod comprises a solid rod having a first end and a second end, wherein said first end includes a handle used by a user for holding said drink purifying device;
wherein said elongated rod comprises a material composition selected from a group consisting of a copper and a hydrogen peroxide to attract and adhere sulphites in the liquid medium thereto, and to kill pathogens therein;
wherein the liquid medium is but limited to, a drinking liquid medium selected from a group consisting of a water, a juice, and a wine;
wherein said handle is buoyant;
wherein said elongated rod includes a diameter generally from about Diameter Nominal (DN) 2 mm to about Diameter Nominal (DN) 20 mm; and
further wherein said elongated rod includes a length generally from about 4 inches to about 8 inches.

19. The drink purifying device of claim 18, wherein said handle comprises a material selected from a group consisting of any food grade and FDA approved material.

20. The drink purifying device of claim 19, wherein said pathogens is selected from a group consisting of a bacteria, an algae, a virus, a microorganism, a mold and a fungi.
